(19) United States
(12) Patent Application Publication
(10) Pub. No.: US 2024/0154264 A1
(43) Pub. Date: May 9, 2024

(54) BATTERY AND METHOD FOR MANUFACTURING BATTERY

(71) Applicant: Panasonic Intellectual Property Management Co., Ltd., Osaka (JP)

(72) Inventors: TAKAHIRO INOUE, Nara (JP); YASUNOBU KODAMA, Hyogo (JP); HIDEYUKI UEDA, Osaka (JP)

(21) Appl. No.: 18/549,913

(22) PCT Filed: Feb. 4, 2022
(86) PCT No.: PCT/JP2022/004534

§ 371 Date: Sep. 10, 2023

(30) Foreign Application Priority Data
Mar. 16, 2021 (JP) 2021-042584

(51) Int. Cl. H01M 50/533; H01M 50/107; H01M 50/184; H01M 50/188; H01M 50/536

(52) U.S. Cl. CPC H01M 50/533; H01M 50/107; H01M 50/184; H01M 50/188; H01M 50/536

(57) ABSTRACT

The disclosed battery includes a cylindrical side surface, a case including an opening and a bottom, an electrode group housed in the case together with an electrolytic solution and including a first electrode and a second electrode, and a first end part electrically connected to the first electrode, a first lead welded to the cylindrical side surface, a cap for sealing an opening, and a gasket provided between the opening and the cap. A part of the cylindrical side surface is provided with a groove for compressing a part of the gasket. The gasket includes a cylindrical part that is continuous with a compression part and that extends toward the bottom. The first lead is not placed between the cylindrical side surface and the compression part, and is in contact with the cylindrical part. The second end part of the first lead is positioned closer to the opening than the electrode group.

### TECHNICAL FIELD

The present disclosure relates to a battery and a method for manufacturing a battery.

### BACKGROUND ART

A conventionally known battery includes a bottomed cylindrical case; an electrode group housed in the case together with an electrolytic solution; a lead electrically connected to one electrode of the electrode group and the case; a cap for sealing an opening of the case; and a gasket provided between the opening and the cap (for example, PTL 1). In the battery of PTL 1, a case side surface is provided with an annular groove protruding inward of the case, and the lead is sandwiched between the part provided with the groove in the case side surface and the gasket.

### CITATION LIST

### Patent Literature

PTL 1: Japanese Patent Application Unexamined Publication No. 2006-278195

### SUMMARY OF THE INVENTION

However, with a configuration of PTL 1, an electrolytic solution housed in a case may easily leak to the outside (that is, leakage resistance may be reduced). This is because although it is important that a part provided with a groove in a case side surface and a gasket are adhesively attached to each other in order to enhance the leakage resistance, a lead is sandwiched between the part provided with the groove in the case side surface and the gasket to damage the adhesion as mentioned above. In such a circumstance, one object of the present disclosure is to enhance the leakage resistance of a battery.

One aspect of the present disclosure relates to a battery. The battery includes a case including a cylindrical side surface, and including an opening at a first end and a bottom at a second end; an electrode group housed in the case together with an electrolytic solution, and including a first electrode and a second electrode with a different polarity from the first electrode; a first lead including a first end part electrically connected to the first electrode and a second end part opposite to the first end part and welded to the cylindrical side surface; a cap for sealing the opening; and a gasket provided between the opening and the cap, wherein a part of the cylindrical side surface includes an annular groove protruding inward of the case and compressing a part of the gasket, the gasket includes a cylindrical part being continuous with a compression part that is the part compressed and extending toward the bottom, the first lead is not placed between the cylindrical side surface and the compression part, and is brought into contact with the cylindrical part, and the second end part of the first lead is positioned closer to the opening than the end part close to the opening in the electrode group.

Another aspect of the present disclosure relates to a method for manufacturing a battery. The method is a method for manufacturing a battery in which the first lead is bent to be convex toward the opening closer to the second end than the welded part. The method includes a first step of housing the electrode group in the case, in which the first end part of the first lead is electrically connected to the case; a second step of welding the first lead to the cylindrical side surface; a third step of forming the groove in a part of the cylindrical side surface; and a fourth step of press-fitting the gasket into the case. The fourth step includes pressing and bending the first lead by the gasket to allow the second end of the first lead to be displaced toward the bottom.

The present disclosure can enhance leakage resistance of a battery.

### BRIEF DESCRIPTION OF DRAWINGS

FIG. 1 is a sectional view schematically showing a battery in accordance with a first exemplary embodiment.

FIG. 2 is a sectional view schematically showing a battery in accordance with a second exemplary embodiment.

FIG. 3 is a sectional view for illustrating each dimension in the battery.

### DESCRIPTION OF EMBODIMENTS

Exemplary embodiments of a battery and a method for manufacturing a battery according to the present disclosure are descried below with examples. However, the present disclosure is not limited to the below-mentioned examples. In the following description, specific numerical values and materials are described as examples, but other numerical values and materials may be applied as long as the effect of the present disclosure is obtained.

Battery

A battery according to the present disclosure includes a case, an electrode group, a first lead, a cap, and a gasket.

The case is in a bottomed cylindrical shape, and includes a cylindrical side surface, and an opening at a first end and a bottom at a second end. The case may be bottomed circular cylindrical, bottomed oval cylindrical, or bottomed prismatic cylindrical. A part of the cylindrical side surface is provided with an annular groove protruding inward of the case (that is, inside of the case in the radial direction) to compress a part of the gasket. The annular groove may be formed in the vicinity of the opening. The case is made of conductive materials. For example, the case is made of stainless steel being 0.05 mm to 0.2 mm in thickness, but is not limited thereto.

The electrode group is housed in the case together with an electrolytic solution. The electrode group includes a first electrode and a second electrode with a different polarity from the first electrode. The electrode group may be formed as a columnar shape obtained by winding the first electrode and the second electrode with a separator placed therebetween. The first electrode may include a first current collecting sheet and first active material layers formed on both surfaces of the first current collecting sheet. The second electrode may include a second current collecting sheet and second active material layers formed on both surfaces of the second current collecting sheet.

The first electrode is coupled to the inner peripheral surface of the conductive case via the first lead. The second electrode may be coupled to a conductive cap via the second lead. Herein, the case may function as a first terminal (for example, a negative electrode terminal) of the battery, and the cap may function as a second terminal (for example, a positive electrode terminal).

A case where the first electrode and the second electrode are respectively the negative electrode and the positive electrode is described in more detail.

The negative electrode includes a negative electrode current collector sheet, and a negative electrode active material layer formed on both surfaces of the negative electrode current collector sheet. Well-known negative active material sheets can be used as the negative electrode current collector sheet. When the battery is a lithium-ion secondary battery, a foil of metal such as stainless steel, nickel, copper, and copper alloys, is used. The thickness is, for example, 5 m to 20 μm, but is not limited thereto.

The negative electrode active material layer includes a negative electrode active material as an essential component, and a binder, a conductive agent, and the like, as an optional component. Well-known negative active materials can be used as negative active materials. When the battery is a lithium-ion secondary battery, for example, metal lithium, alloys such as silicon alloys and tin alloys, carbon materials such as graphite and hard carbon, silicon compounds, tin compounds, and lithium titanate are used. In particular, since metallic lithium itself exhibits high conductivity and flexibility, the use of a negative current collector sheet is optional. The thickness of the negative electrode active material is, for example, 70 μm to 150 μm, but is not limited thereto.

Materials such as nickel, nickel alloy, iron, stainless steel, copper, and a copper alloy can be used for the negative electrode current collecting lead (first lead) of a lithium-ion secondary battery. The thickness is, for example, 10 μm to 120 μm, but is not limited thereto. The negative electrode current collecting lead may be connected to the inner surface of the cylindrical side surface in the vicinity of the opening of the case.

The positive electrode includes a positive electrode current collector sheet, and positive electrode active material layers formed on both surfaces of the positive electrode current collector sheet. Well-known positive electrode current collector sheets can be used as the positive electrode current collector sheet. When the battery is a lithium-ion secondary battery, a foil of metal such as aluminum and aluminum alloys, is used. The thickness is, for example, 5 μm to 20 μm, but is not limited thereto.

The positive electrode active material layer includes a positive electrode active material as an essential component, and includes a binder, a conductive agent, and the like, as optional components. As the positive electrode active material, well-known positive electrode active materials can be used, and as the positive electrode active material of the lithium-ion secondary battery, a lithium-containing composite oxide is preferable, and, for example, LiCoO₂, LiNiO₂, LiMn₂O₄, or the like, is used. As the positive electrode active material of the lithium primary battery, manganese dioxide, graphite fluoride, or the like, is used. The thickness of the positive electrode active material layer is, for example, 20 μm to 130 μm, but is not limited thereto.

As the positive electrode current collecting lead (second lead) of a lithium-ion secondary battery, for example, a material such as aluminum, an aluminum alloy, nickel, a nickel alloy, iron, and stainless steel can be used. The thickness is, for example, 10 μm to 120 μm, but is not limited thereto. The positive electrode current collecting lead may pass through the inner space of the cylindrical part (mentioned later) of the gasket and may be coupled to the bottom surface of the cap also serving as a positive electrode terminal.

Well-known separators can be used as a separator disposed between the negative electrode and the positive electrode, and formed of, for example, an insulating microporous thin film, woven or nonwoven fabric. For the separator of the lithium-ion secondary batteries, for example, polyolefins such as polypropylene and polyethylene can be used. The thickness may be 10 μm to 50 μm, and preferably 10 μm to 30 μm.

As the electrolytic solution, well-known electrolytic solutions can be used. When the battery is a lithium-ion secondary battery, the electrolytic solution includes a well-known lithium salt and a well-known non-aqueous solvent. Examples of the non-aqueous solvent include a cyclic carbonate ester, a chain carbonate ester, a cyclic carboxylate ester, or the like. Furthermore, examples of lithium salts include LiPF₆, LiBF₄, or the like, but are not limited thereto.

The first lead includes a first end part electrically connected to the first electrode and a second end part opposite to the first end. The first lead is welded to the cylindrical side surface of the case. The first lead may be the above-mentioned negative electrode current collecting lead mentioned above.

The cap seals the opening of the case. The cap may include a conductive material.

The gasket is provided between the opening of the case and the cap. The gasket includes a compression part that is the part compressed by the annular groove. In this compression part, the gasket is adhesively attached to a part formed in the groove of the case. The compression part may be compressed over the entire surface of the gasket (or over the entire surface of the case). The gasket includes a cylindrical part being continuous with the compression part and extending toward the bottom of the case.

The gasket is made of an insulating material and electrically insulates the case from the cap. The gasket is preferably made of materials with resistance to electrolytes, and, for example, fluororesin, polyolefin, polyamide, and the like. Among them, fluororesin is preferably used, for example, tetrafluoroethylene perfluoroalkoxy vinyl ether copolymer (PFA) can be used.

As the characteristic parts of the present disclosure, the first lead is not placed between the cylindrical side surface of the case and the compression part of the gasket, and is brought into contact with the cylindrical part of the gasket. Furthermore, the second end part of the first lead is positioned closer to the opening than the end part close to the opening in the electrode group. In this way, the first lead includes a part welded to the case and is sufficiently long, but is not brought into contact with the electrode group. Therefore, even if the length of the first lead includes a tolerance, the first lead can be welded to the case (specifically, the cylindrical side surface), and the internal short circuit of the battery can be avoided. Furthermore, the first lead is sufficiently long, but the first lead is not placed between the case and the gasket. Therefore, the adhesion between the case and the gasket is not impaired and the leakage resistance of the battery can be enhanced.

The relation: 0.91≤D2/D1≤0.96 may be satisfied where D1 [mm] is a distance between the bottom of the case and the deepest part of the groove and D2 [mm] is a distance between the bottom of the case and the end part close to the opening side of the electrode group, along the axis of the case. With this configuration, by increasing the volume occupied by the electrode group in the case, the discharge capacity of the battery can be enhanced. Note here that when 0.91≤D2/D1 is satisfied, the distance between the deepest part of the groove and the welded site is extremely short. In this case, it is more effective to make the length of the part closer to the second end part sufficiently longer than the welding site of the first lead, rather than preventing the first lead from being placed between the cylindrical side surface and the compression part.

The first lead may be welded to a region provided with the groove in the cylindrical side surface of the case. Since the groove is usually formed in the vicinity of the opening of the case, this configuration can secure a distance between the electrode group and the welded site. The end part close to the opening of the electrode group can be easily made near to the opening, the occupied volume of the electrode group in the case can be increased. Therefore, the discharge capacity of the battery can be enhanced. Note here that a region provided with the groove in the cylindrical side surface is not only the deepest part of the groove but also an entire region in which the outer diameter is gradually reduced toward the deepest part. The welded site is provided closer to the bottom of the case than the deepest part of the groove.

The outer diameter of the case may be 6 mm or less. The configuration of the present disclosure is particularly effective in the battery including a case with the outer diameter of 6 mm or less. The outer diameter of the case may be 4.5 mm or less. The outer diameter of the case may be 3 mm or more in consideration of the reality in production.

The first lead may be bent to be convex toward the opening of the case on the second end part side than the welded part. With this configuration, the second end part of the first lead extends toward the bottom of the case. For example, the first lead may be bent in a U-letter shape to be convex toward the opening of the case. The first lead thus bent is less likely placed between the case and the gasket. Therefore, it is easy to avoid damage of the leakage resistance of the battery.

The first lead may be brought into contact with the cylindrical part of the gasket in the part closer to the second end part than the bent part mentioned above. Such contact may be any one of point contact, line contact, and face contact.

The second end part of the first lead may be brought into contact with the cylindrical part of the gasket. With this configuration, the first lead is not bent to be convex toward the opening of the case. However, the first lead is long enough so that the second end part is brought into contact with the cylindrical part of the gasket. In other words, the length of the first lead is designed to be long enough so that at least the second end is brought into contact with the cylindrical part of the gasket and is not placed between the cylindrical side surface and the compression part of the gasket. When manufacturing a substantial number of batteries with such a design, for many batteries, the first lead is brought into contact with the cylindrical part of the gasket in the part closer to the second end side than the bent part as described above, and for the remaining batteries, at least the second end part is brought into contact with the cylindrical part of the gasket. In other words, in principle, in any batteries, the second end part is placed between the cylindrical side surface and the compression part of the gasket.

(Method for Manufacturing Battery)

A method for manufacturing a battery according to the present disclosure is a method for manufacturing a battery in which a first lead is bent to be convex toward an opening of a case, and the method includes a first step, a second step, a third step, and a fourth step.

The first step includes housing the electrode group into the case, the electrode group including the first end part of the first lead electrically connected to the first electrode. To the second electrode of the electrode group, one end of the second lead may be electrically connected.

The second step includes welding the first lead to the cylindrical side surface. Types of welding include laser welding, spot welding, resistance welding, or the like.

The third step includes forming an annular groove in a part of the cylindrical side surface of the case. The annular groove may be formed by, for example, a grooving process for reducing the diameter of a part of the cylindrical side surface.

The fourth step includes press-fitting the gasket into the case. Thus, a part of the gasket is compressed by the groove. Herein, when the gasket is press-fitted into the case, the first lead is pressed and bent by the gasket so that the second end part of the first lead is displaced toward the bottom of the case. This pressing bending is carried out by pressure applied from the gasket when the second end part of the first lead or a place in the vicinity of the second end part of the first lead is brought into contact with or engaged with the gasket during press-fitting the gasket into the case, in a case where the second end part is sufficiently long so that the second end part is brought into contact with the cylindrical part of the gasket. As a result, the first lead is bent to be convex toward the opening of the case.

As mentioned above, the present disclosure can appropriately weld the first lead to the case regardless of the tolerance of the length of the first lead, and can enhance the leakage resistance of the battery. In addition, the present disclosure can easily produce such a battery.

Hereinafter, an example of a battery and a method for manufacturing a battery according to the present disclosure is specifically described with reference to drawings. The above-mentioned component elements and steps mentioned above can be applied to the component elements and steps of the battery and the method for manufacturing a battery of one example described below. The battery and the method for manufacturing a battery of one example described below can be changed based on the above description. Furthermore, the matter described below may be applied to the above-mentioned exemplary embodiment. Among the component elements and steps of the battery and the method for manufacturing a battery of one example described below, the component elements and steps that are not essential to the battery and the method for manufacturing a battery according to the present disclosure may be omitted. Note here that the drawings shown below are schematic and do not accurately reflect the shape or number of actual members.

### First Exemplary Embodiment

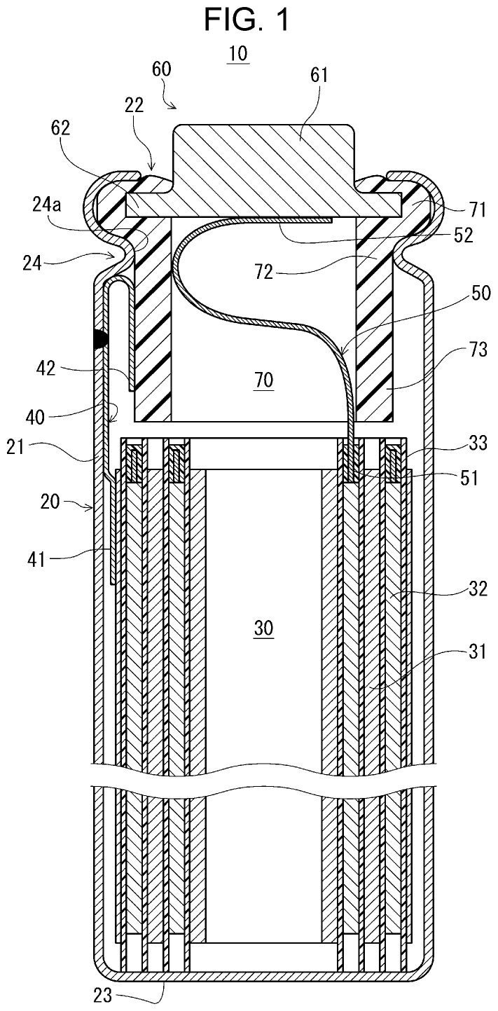

A first exemplary embodiment of the present disclosure is described. As shown in FIG. 1, battery 10 of this exemplary embodiment includes case 20, electrode group 30, first lead 40, second lead 50, cap 60, and gasket 70.

Case 20 is formed in a bottomed circular-cylindrical shape. Case 20 includes cylindrical side surface 21, opening 22 at a first end (the upper end in FIG. 1), and bottom 23 at a second end (the lower end in FIG. 1). In a part in the vicinity of opening 22 of cylindrical side surface 21, annular groove 24 protruding inward of the case is formed. Groove 24 compresses a part of gasket 70. Note here that a part compressed by groove 24 of gasket 70 is also referred to as compression part 72. Case 20 is formed of stainless steel with a thickness of 0.05 mm to 0.2 mm. The outer diameter of case 20 may be 3 mm or more and 6 mm or less, and may be 3 mm or more and 4.5 mm or less.

Electrode group 30 is housed in case 20 together with an electrolytic solution (not shown). Electrode group 30 includes first electrode 31 and second electrode 32 with a different polarity from first electrode 31. In this exemplary embodiment, first electrode 31 forms a negative electrode, and second electrode 32 forms a positive electrode, but is not limited thereto. Electrode group 30 is formed by winding first electrode 31 and second electrode 32 with separator 33 placed therebetween. First electrode 31 includes a first current collecting sheet, and first active material layers (negative electrode active material layers in this example) formed on both surfaces of the first current collecting sheet (both are not shown). Second electrode 32 includes a second current collecting sheet and second active material layers (positive electrode active material layers in this example) formed on both surfaces of the second current collecting sheet (both are not shown).

First electrode 31 is coupled to the inner peripheral surface of case 20 via first lead 40. Second electrode 32 is coupled to cap 60 via second lead 50. In this exemplary embodiment, case 20 functions as the negative electrode terminal of battery 10, and cap 60 functions as the positive electrode terminal of battery 10, but is not limited thereto.

First lead 40 includes first end part 41 electrically connected to first electrode 31 and second end part 42 opposite to first end 41. First lead 40 is welded to cylindrical side surface 21 of case 20. In more detail, first lead 40 is welded to a part closer to bottom 23 than groove 24 in cylindrical side surface 21. However, although not shown, first lead 40 may be welded to a region including groove 24 in cylindrical side surface 21. First lead 40 of this exemplary embodiment is a negative electrode current collecting lead.

Second lead 50 includes third end part 51 electrically connected to second electrode 32, and forth end part 52 electrically connected to cap 60. Second lead 50 passes through the inner space of below-mentioned cylindrical part 73 in gasket 70. Forth end part 52 of second lead 50 is welded to the bottom surface of cap 60. Second lead 50 in this exemplary embodiment is a positive electrode current collecting lead.

Cap 60 seals opening 22 of case 20. Cap 60 is made of a conductive material. Cap 60 functions as a positive electrode terminal of battery 10 as mentioned above. Cap 60 includes terminal part 61 extending along the axis of battery 10, and flange 62 extending outward in the diameter direction of battery 10. Terminal part 61 and flange 62 are formed unitarily with each other. Flange 62 is held by the below-mentioned sealing part 71 of gasket 70.

Gasket 70 is provided between opening 22 of case 20 and cap 60. Gasket 70 is made of an insulating material, and electrically insulates case 20 from cap 60. Gasket 70 includes sealing part 71 that houses cap 60, compression part 72 being continuous with sealing part 71, and cylindrical part 73 being continuous with compression part 72 and extending toward bottom 23 of case 20. Sealing part 71 includes a supporting part for supporting the lower surface of flange 62 of cap 60, and a holding part for holding the upper surface of flange 62. Compression part 72 is compressed by groove 24 over the entire periphery of gasket 70. In a state before compression, the outer diameter of compression part 72 and the outer diameter of cylindrical part 73 are substantially equal to each other, and larger than the smallest diameter of groove 24 (that is, the inner diameter of deepest part 24a of groove 24).

Herein, first lead 40 is not placed between cylindrical side surface 21 of case 20 and compression part 72 of gasket 70, and is brought into contact with cylindrical part 73 of gasket 70. Furthermore, second end part 42 of first lead 40 is positioned closer to opening 22 (closer to the upper side in FIG. 1) than the end part close to opening 22 of electrode group 30 (upper end part of FIG. 1). In other words, second end part 42 of first lead 40 is not brought into contact with electrode group 30. The end part (upper end part) close to opening 22 of electrode group 30 may be, for example, an end part of an insulating member (for example, a separator) that is the most protruding in the end surface of electrode group 30.

First lead 40 is bent to be convex toward opening 22 of case 20 on the side closer to second end part 42 than apart welded to cylindrical side surface 21. First lead 40 is brought into contact with cylindrical part 73 of gasket 70 in a part closer to second end part 42 than the thus bent part. Second end part 42 of first lead 40 faces electrode group 30 along the axis of battery 10 at a predetermined interval. First lead 40 is generally in an inverted U-shape or an inverted J-shape viewed in a cross-sectional view.

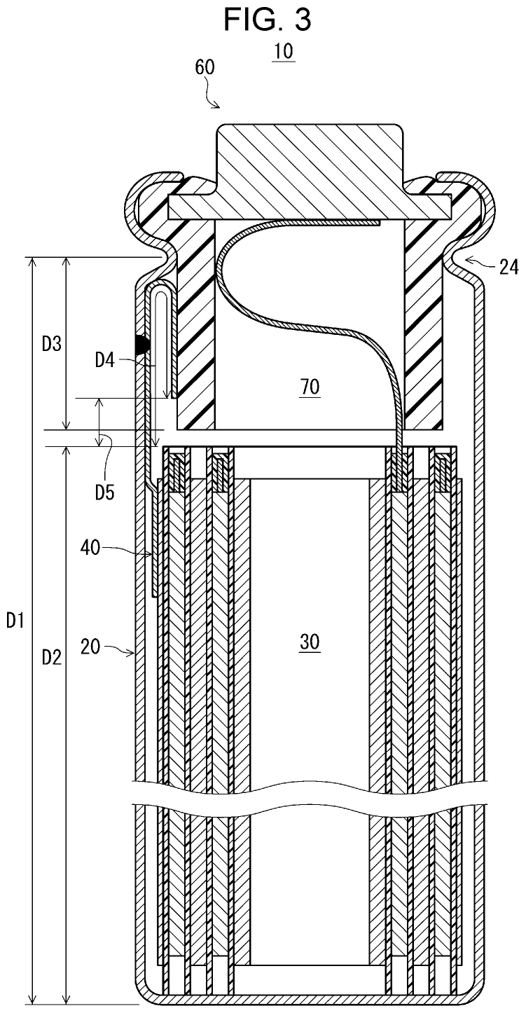

Furthermore, along the axis of case 20, a distance between bottom 23 of case 20 (specifically, the outer surface of bottom 23) and deepest part 24a of groove 24 is referred to as D1 [mm], and a distance between bottom 23 of case 20 (specifically, the outer surface of bottom 23) and the upper end part of electrode group 30 is referred to as D2 [mm] (see FIG. 3). In this case, battery 10 of this exemplary embodiment satisfies 0.91≤D2/D1≤0.96. In the conditions, for example, D1 may be 18 mm to 19 mm, and D2 may be 16.5 mm to 17.5 mm. However, such conditions may not be satisfied.

Method for Manufacturing Battery

Next, a method for manufacturing a battery according to this exemplary embodiment is described. The method includes a first step, a second step, a third step, a fourth step, a fifth step, a sixth step, and a seventh step.

The first step includes housing electrode group 30 into case 20, and electrode group 30 includes first end part 41 of first lead 40, which is electrically connected to first electrode 31, and third end part 51 of second lead 50, which is electrically connected to second electrode 32. When electrode group 30 is housed in case 20, electrode group 30 is inserted into case 20 from opening 22 so that first lead 40 and second lead 50 extend toward opening 22 of case 20 (upward in FIG. 1).

The second step includes welding first lead 40 to cylindrical side surface 21 of case 20. In this exemplary embodiment, first lead 40 is welded to cylindrical side surface 21 by resistance welding.

The third step includes forming annular groove 24 in a part of cylindrical side surface 21 of case 20 (in this example, a part in the vicinity of opening 22). More specifically, annular groove 24 is formed in a region in which first lead 40 extends. Therefore, in a state in which groove 24 is formed, a part of first lead 40 (that is, a part including second end part 42) is pushed inward of the case during formation of groove 24, and protrudes inward of the case than deepest part 24a of groove 24. Groove 24 in this exemplary embodiment is formed by a grooving process for reducing the diameter of a part of cylindrical side surface 21.

The fourth step includes press-fitting (inserting) gasket 70 into case 20. At this time, a part protruding inward of the case than groove 24 in first lead 40 (that is, a part including second end part 42) is pressed down by gasket 70. In other words, when gasket 70 is press-fitted into case 20, first lead 40 is pressed and bent by gasket 70 so that second end part 42 of first lead 40 is displaced toward bottom 23 of case 20. Thus, first lead 40 is bent to be convex toward opening 22 of case 20.

The fifth step includes drawing second lead 50 from the inside of cylindrical part 73 of gasket 70, and welding it to cap 60. In this exemplary embodiment, second lead 50 is welded to the bottom of cap 60 by ultrasonic welding.

The sixth step includes injecting an electrolytic solution into the inside of case 20 by the vacuum injection method. At this time, since annular groove 24 and gasket 70 are adhesively attached to each other, penetration of the electrolytic solution to a part above annular groove 24 can be prevented.

The seventh step includes housing cap 60 into sealing part 71 of gasket 70. Then, by caulking opening 22 of case 20 into cap 60 via gasket 70, battery 10 of this exemplary embodiment can be obtained.

### Second Exemplary Embodiment

A second exemplary embodiment of the present disclosure is described. This exemplary embodiment is different from the first exemplary embodiment mentioned above in the configuration of first lead 40. Hereinafter, the different points from the first exemplary embodiment mentioned above are mainly described.

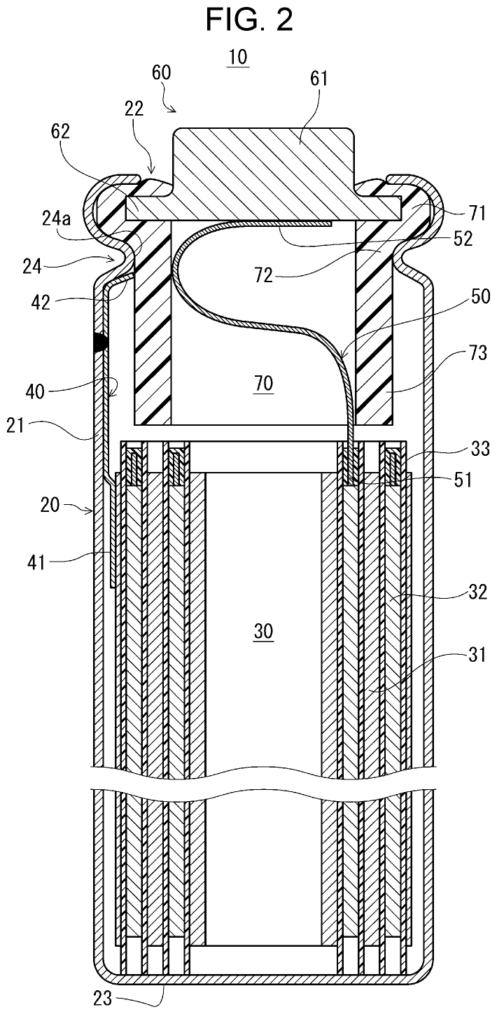

As shown in FIG. 2, in first lead 40 of this exemplary embodiment, second end part 42 is brought into contact with cylindrical part 73 of gasket 70. First lead 40 is not bent to be convex upward. The other configurations are the same as those of the first exemplary embodiment.

### EXAMPLES

For batteries 10 of Examples 1 to 3 and Comparative Examples 1 to 3 shown below, the relation between various conditions including dimensions D1 to D5 of the parts shown in FIG. 3, and leakage resistance, presence or absence of internal short-circuit, and the discharge capacity is evaluated.

Herein, dimension D1 is a distance between bottom 23 of case 20 and deepest part 24a of groove 24 along the axis of case 20. Dimension D2 is a distance between bottom 23 of case 20 and the end part (upper end part) close to opening 22 of electrode group 30 along the axis. The end part (upper end part) of near opening 22 of electrode group 30 may be, for example, an end part of separator 33 most protruding in the end surface of electrode group 30. Dimension D3 is a distance between the lower end of cylindrical part 73 of gasket 70 and deepest part 24a of groove 24 along the axis. Dimension D4 is a length along first lead 40 from the basic point to second end part 42 in first lead 40. The basic point is the same height position as the upper end part of electrode group 30. Then, dimension D5 is a distance between the upper end part of electrode group 30 and second end part 42 of first lead 40 along the axis.

As a method for evaluating leakage resistance, battery 10 is initially charged, then subjected to high-temperature aging and charging and discharging to adjust the SOC (state of charge) to 100%, then stored for 20 days in a constant temperature and humidity environment of 60° C. and 90% humidity, and the presence or absence of leakage from the opening 22 of case 20 and gasket 70 is evaluated. The number of samples at this time is 20 for each Example and each Comparative Example, and the case where no leakage occurs in all 20 samples is evaluated as “not occur” and the other cases (for example, when leakage occurs by microscope observation or by visual observation) are evaluated as “occur”.

As a method for evaluating the discharge capacity, battery 10 is initially charged, then subjected to high-temperature aging and charging and discharging to adjust the SOC to 100%. Then, after discharging 90% of the capacity at 2 C and providing a rest time for one minute, discharging 7% of the capacity at 1 C, and providing a rest time for one minute, finally discharging the remaining capacity (3%) at 0.2 C, the discharge capacity during this series of discharging is evaluated. Note here that in the following, the discharge capacity of Comparative Example 1 is defined as a reference value (100), and the discharge capacities of Examples 1 to 3 and Comparative Examples 2 and 3 are represented as ratios to the reference value.

### Example 1

The outer diameter of battery 10 is 3.51 mm, and an axial length of battery 10 is 19.75 mm. The inner diameter of deepest part 24a of groove 24 is 2.78 mm, and the outer diameter of cylindrical part 73 of gasket 70 is 2.88 mm. Therefore, gasket 70 is press-fitted in case 20. First lead 40 is welded to cylindrical side surface 21 of case 20 in a position that is upper by 0.5 mm or more than the upper end part of electrode group 30. First lead 40 is not placed between case 20 and gasket 70. Second end part 42 of first lead 40 and the upper end part of electrode group 30 are not brought into contact with each other. D1 is 18.59 mm, D2 is 16.999 mm, D3 is 1.271 mm, D4 is 1.39 mm, and D5 is 1.331 mm. The above-described evaluations are carried out in these conditions to obtain the results that no leakage occurs, no inner short-circuit occurs, and the discharge capacity is 102.7.

### Example 2

The outer diameter of battery 10 is 3.51 mm, and an axial length of battery 10 is 19.75 mm. The inner diameter of deepest part 24a of groove 24 is 2.78 mm, and the outer diameter of cylindrical part 73 of gasket 70 is 2.88 mm. Therefore, gasket 70 is press-fitted in case 20. First lead 40 is welded to cylindrical side surface 21 of case 20 in a position that is upper by 0.5 mm or more than the upper end part of electrode group 30. First lead 40 is not placed between case 20 and gasket 70. Second end part 42 of first lead 40 and the upper end part of electrode group 30 are not brought into contact with each other. D1 is 18.59 mm, D2 is 17.449 mm, D3 is 0.821 mm, D4 is 1.39 mm, and D5 is 1.016 mm. The above-described evaluations are carried out in these conditions to obtain the results that no leakage occurs, no inner short-circuit occurs, and the discharge capacity is 105.5.

### Example 3

The outer diameter of battery 10 is 3.51 mm, and an axial length of battery 10 is 19.75 mm. The inner diameter of deepest part 24a of groove 24 is 2.78 mm, and the outer diameter of cylindrical part 73 of gasket 70 is 2.88 mm. Therefore, gasket 70 is press-fitted in case 20. First lead 40 is welded to cylindrical side surface 21 of case 20 in a position that is upper by 0.5 mm or more than the upper end part of electrode group 30. First lead 40 is not placed between case 20 and gasket 70. Second end part 42 of first lead 40 and the upper end part of electrode group 30 are not brought into contact with each other. D1 is 18.59 mm, D2 is 17.762 mm, D3 is 0.508 mm, D4 is 1.39 mm, and D5 is 0.39 mm. The above-described evaluations are carried out in these conditions to obtain the results that no leakage occurs, no inner short-circuit occurs, and the discharge capacity is 107.4.

### Comparative Example 1

The outer diameter of battery 10 is 3.51 mm, and an axial length of battery 10 is 19.75 mm. The inner diameter of deepest part 24a of groove 24 is 2.78 mm, and the outer diameter of cylindrical part 73 of gasket 70 is 2.68 mm. Therefore, gasket 70 is not press-fitted in case 20. First lead 40 is welded to cylindrical side surface 21 of case 20 in a position that is upper by 0.5 mm or more than the upper end part of electrode group 30. First lead 40 is not placed between case 20 and gasket 70. Second end part 42 of first lead 40 and the upper end part of electrode group 30 are not brought into contact with each other. D1 is 18.59 mm, D2 is 16.6 mm, D3 is 1.67 mm, and D4 is 1.39 mm. The above-described evaluations are carried out in these conditions to obtain the results that no leakage occurs, no inner short-circuit occurs, and the discharge capacity is 100.

### Comparative Example 2

The outer diameter of battery 10 is 3.51 mm, and an axial length of battery 10 is 19.75 mm. The inner diameter of deepest part 24a of groove 24 is 2.78 mm, and the outer diameter of cylindrical part 73 of gasket 70 is 2.68 mm. Therefore, gasket 70 is not press-fitted in case 20. First lead 40 is welded to cylindrical side surface 21 of case 20 in a position that is upper by 0.5 mm or more than the upper end part of electrode group 30. First lead 40 is not placed between case 20 and gasket 70 (the state is similar to that of PTL 1). Second end part 42 of first lead 40 and the upper end part of electrode group 30 are not brought into contact with each other. D1 is 18.59 mm, D2 is 17.762 mm, D3 is 0.508 mm, D4 is 1.39 mm, and D5 is 0.39 mm. The above-described evaluations are carried out in these conditions to obtain the results that leakage occurs, no inner short-circuit occurs, and the discharge capacity is 107.4.

### Comparative Example 3

The outer diameter of battery 10 is 3.51 mm, and an axial length of battery 10 is 19.75 mm. The inner diameter of deepest part 24a of groove 24 is 2.78 mm, and the outer diameter of cylindrical part 73 of gasket 70 is 2.88 mm. Therefore, gasket 70 is press-fitted in case 20. First lead 40 is welded to cylindrical side surface 21 of case 20 in a position that is upper by 0.5 mm or more than the upper end part of electrode group 30. First lead 40 is not placed between case 20 and gasket 70. Second end part 42 of first lead 40 and the upper end part of electrode group 30 are brought into contact with each other. D1 is 18.59 mm, D2 is 18.212 mm, D3 is 0.058 mm, D4 is 1.39 mm, D5 is −0.06 mm (herein, negative value of D5 means that second end part 42 of first lead 40 and the upper end part of electrode group 30 are brought into contact with each other). The above-described evaluations are carried out in these conditions to obtain the results that no leakage occurs, inner short-circuit occurs, and the discharge capacity is 110.1.

Note here that the list of the dimensions 1 to D5 and the evaluation results of Examples 1 to 3 and Comparative Examples 1 to 3 is shown in Table 1. In Table 1, units of D1 to D5 are mm.

TABLE 1

| | | | | | | | | | Inner short | Discharge |
|---|---|---|---|---|---|---|---|---|---|---|
| | D1 | D2 | D3 | D4 | D5 | D2/D1 | D5/D2 | Leakage | circuit | capacity |
| Co. Ex. 1 | 18.59 | 16.6 | 1.67 | 1.39 | — | 0.89 | — | Not | Not | 100 |
| | | | | | | | | occur | occur | |
| Ex. 1 | 18.59 | 16.999 | 1.271 | 1.39 | 1.331 | 0.91 | 0.078 | Not | Not | 102.7 |
| | | | | | | | | occur | occur | |
| Ex. 2 | 18.59 | 17.449 | 0.821 | 1.39 | 1.016 | 0.94 | 0.058 | Not | Not | 105.5 |
| | | | | | | | | occur | occur | |
| Ex. 3 | 18.59 | 17.762 | 0.508 | 1.39 | 0.39 | 0.96 | 0.022 | Not | Not | 107.4 |
| | | | | | | | | occur | occur | |
| Co. Ex. 2 | 18.59 | 17.762 | 0.508 | 1.39 | 0.39 | 0.96 | 0.022 | Occur | Not | 107.4 |
| | | | | | | | | | occur | |
| Co. Ex. 3 | 18.59 | 18.212 | 0.058 | 1.39 | −0.06 | 0.98 | −0.003 | Not | Occur | 110.1 |
| | | | | | | | | occur | | |

Co. Ex. = Comparative Example,
Ex. = Example

As mentioned above, in batteries 10 of Examples 1 to 3, no leakage and no inner short circuit occur, and high discharge capacity is obtained. On the other hand, in battery 10 of Comparative Example 1, no leakage and no inner short circuit occur, but the discharge capacity is low. Furthermore, in batteries 10 of Comparative Examples 2 and 3, the discharge capacity is high, but leakage or inner short-circuit occurs. From these results, it can be said that the superiority of each Example over each Comparative Example is demonstrated.

### INDUSTRIAL APPLICABILITY

A battery according to the present disclosure can be used for a battery and a method for manufacturing a battery.

### REFERENCE MARKS IN THE DRAWINGS

10: battery
20: case
21: cylindrical side surface
22: opening
23: bottom
24: groove
24a: deepest part
30: electrode group
31: first electrode
32: second electrode
33: separator
40: first lead
41: first end part
42: second end part
50: second lead
51: third end part
52: forth end part
60: cap
61: terminal part
62: flange
70: gasket
71: sealing part
72: compression part
73: cylindrical part

1. A battery comprising:
a case including a cylindrical side surface, and including an opening at a first end of the case and a bottom at a second end of the case;
an electrode group housed in the case together with an electrolytic solution, and including a first electrode and a second electrode with a different polarity from a polarity of the first electrode;
a first lead including a first end part electrically connected to the first electrode and a second end part opposite to the first end part and a welded part that is welded to the cylindrical side surface;
a cap for sealing the opening, and
a gasket provided between the opening and the cap,
wherein
a part of the cylindrical side surface includes an annular groove protruding inward of the case and compressing a part of the gasket,
the gasket includes a cylindrical part being continuous with a compression part that is the part compressed and extending toward the bottom,
the first lead is in contact with the cylindrical part, and the compression part is in direct contact cylindrical side surface, and
the second end part of the first lead is positioned closer to the opening than to the end part of the electrode group, the end part being close to the opening in the electrode group.

2. The battery according to claim 1, wherein 0.91≤D2/D1≤0.96 is satisfied where D1 [mm] is a distance between the bottom and a deepest part of the annular groove and D2 [mm] is a distance between the bottom and the end part of the electrode group, along an axis of the case.

3. The battery according to claim 1, wherein the welded part of the first lead is welded to a region provided with the annular groove in the cylindrical side surface.

4. The battery according claim 1, wherein an outer diameter of the case is 6 mm or less.

5. The battery according to claim 1, wherein the first lead includes a bent part that is bent to be convex toward the opening, between the second end part and the welded part.

6. The battery according to claim 5, wherein the first lead is in contact with the cylindrical part in a part between the second end part and the bent part.

7. The battery according to claim 1, wherein the second end part of the first lead is in contact with the cylindrical part.

8. A method for manufacturing a battery according to claim 5, the method comprising:
a first step of housing the electrode group into the case, the electrode group including the first end part of the first lead electrically connected to the first electrode;
a second step of welding the first lead to the cylindrical side surface;
a third step of forming the annular groove in a part of the cylindrical side surface; and
a fourth step of press-fitting the gasket into the case,
wherein the fourth step includes pressing and bending the first lead by the gasket to allow the second end of the first lead to be displaced toward the bottom.
